(19) United States
(12) Patent Application Publication
(10) Pub. No.: US 2007/0100889 A1
(43) Pub. Date: May 3, 2007

(54) Information processing device, an information processing method, and an information processing program

(75) Inventor: Masashi Inoue, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/585,144

(22) Filed: Oct. 24, 2006

(30) Foreign Application Priority Data
Oct. 28, 2005 (JP) NO. 2005-314940

(51) Int. Cl. G06F 7/00

(52) U.S. Cl. 707/104.1

(57) ABSTRACT

The present invention provides an information processing device comprising: a storage device which stores a group of data including language data corresponding to a plurality of languages, a language selection device which selects a language used for an operation of the information processing device among the plurality of languages based on an operation input from an operator, and a data deletion device which deletes unselected language data other than language data corresponding to the selected language among the language data stored in the storage device to increase free capacity of the storage device. According to the information processing device of the present invention, free capacity of the storage device can be increased and storage capacity can be effectively utilized by deleting the language data (unselected language data) corresponding to the languages which were not selected as the language used for an operation of the information processing device.

### BACKGROUND OF THE INVENTION

1. Field of the Invention

The present invention relates to an information processing device, an information processing method, and an information processing program, and particularly to an information processing device and the like having an embedded memory for storing data such as image data.

2. Description of the Related Art

In Japanese Patent Application Laid-Open No. 2005-195835, an information processing device is disclosed which enables storage capacity in a flash memory to be saved by compressing multiple types of font data or language data into one compressed data item.

### SUMMARY OF THE INVENTION

In the information processing device, which is disclosed in Japanese Patent Application Laid-Open No. 2005-195835, such as a personal computer, a change of language setting is rarely performed, the compressed data item of multiple types of font data or the language data is not required to be saved, and it results in a problem that storage capacity is used wastefully.

The present invention has been made in view of the above mentioned circumstances, and it is an object of the present invention to provide an information processing device, an information processing method and an information processing program in which storage capacity can be saved in an embedded memory for storing data such as image data.

In order to achieve the above mentioned object, a first aspect of the present invention provides an information processing device comprising: a storage device which stores a group of data including language data corresponding to a plurality of languages; a language selection device which selects a language used for an operation of the information processing device among the plurality of languages based on an operation input from an operator; and a data deletion device which deletes unselected language data other than language data corresponding to the selected language among the language data stored in the storage device to increase free capacity of the storage device.

According to the information processing device of the first aspect, free capacity of the storage device can be increased and storage capacity can be effectively utilized by deleting the language data (unselected language data) corresponding to the languages which were not selected as the language used for an operation of the information processing device.

An information processing device according to a second aspect of the present invention is, in the first aspect, characterized in that the language selection device selects a default language as a language used for an operation of the information processing device if an instruction input for selection of the language used for an operation of the information processing device is not received from the operator, and the data deletion device deletes unselected language data other than language data corresponding to the default language among the language data stored in the storage device.

According to the information processing device of the second aspect, if no change from the default language is performed in the case where the language selection was not performed, free capacity of the storage device can be increased by deleting unnecessary language data.

In order to achieve the above mentioned object, a third aspect of the present invention provides an information processing device comprising: a storage device which stores a group of data including language data corresponding to a plurality of languages; a language selection device which selects a language used for an operation of the information processing device among the plurality of languages based on an operation input from an operator; and a data deletion device which deletes unselected language data other than language data corresponding to the selected language among the language data stored in the storage device to increase free capacity of the storage device if storage capacity of the storage device falls short.

According to the information processing device of the third aspect, if storage capacity of the storage device falls short during an operation of the information processing device, free capacity of the storage device can be increased by deleting the unselected language data.

An information processing device according to a fourth aspect of the present invention is, in the third aspect, characterized in that the language selection device selects a default language as a language used for an operation of the information processing device if an instruction input for selection of the language used for an operation of the information processing device is not received from the operator, and the data deletion device deletes unselected language data other than language data corresponding to the default language among the language data stored in the storage device if storage capacity of the storage device falls short.

According to the information processing device of the fourth aspect, if storage capacity of the storage device falls short during an operation of the information processing device in the case where the language selection was not performed, free capacity of the storage device can be increased by deleting unnecessary language data as required.

An information processing device according to a fifth aspect of the present invention is, in the third or the fourth aspect, characterized in that the storage device stores the unselected language data as a deletion candidate and the data deletion device deletes the language data of the deletion candidate.

According to the information processing device of the fifth aspect, if storage capacity falls short, the unselected language data can be immediately deleted by storing the unselected language data as the deletion candidate.

An information processing device according to a sixth aspect of the present invention is, in the third to fifth aspects, characterized in that the information processing device further comprises an input reception device which receives an instruction input from an operator for instructing whether the unselected language data is to be deleted if storage capacity of the storage device falls short, and characterized in that the data deletion device deletes the unselected language data if an instruction input for instructing to delete the unselected language data is received.

According to the information processing device of the sixth aspect, whether storage capacity is to be reserved by deleting the unselected language data can be selected.

In order to achieve the above mentioned object, a seventh aspect of the present invention provides an information processing method comprising the steps of: storing a group of data which includes language data corresponding to a plurality of languages in a storage device; selecting a language used for an operation of an information processing device among the plurality of languages based on an operation input from an operator; and deleting unselected language data other than language data corresponding to the selected language among the language data stored in the step of storing to increase free capacity of the storage device.

An information processing method according to an eighth aspect of the present invention comprises the steps of: storing a group of data which includes language data corresponding to a plurality of languages in a storage device; selecting a language used for an operation of an information processing device among the plurality of languages based on an operation input from an operator; and deleting unselected language data other than language data corresponding to the selected language among the language data stored in the storage device to increase free capacity of the storage device if storage capacity of the storage device falls short.

An information processing method according to a ninth aspect of the present invention is, in the eighth aspect, characterized by further comprising a step of receiving an instruction input from an operator for instructing whether the unselected language data is to be deleted if storage capacity of the storage device falls short, and in the step of receiving the input, the unselected language data is deleted in the step of deleting the data if an instruction input for instructing to delete the unselected language data is received.

An information processing program according to a tenth aspect of the present invention is characterized by allowing a computer to achieve: a storage function for storing a group of data which includes language data corresponding to a plurality of languages in a storage device; a language selection function for selecting a language used for an operation of an information processing device among the plurality of languages based on an operation input from an operator; and a data deletion function for deleting unselected language data other than language data corresponding to the selected language among the language data stored by the storage function to increase free capacity of the storage device.

An information processing program according to an eleventh aspect of the present invention is characterized by allowing a computer to achieve: a storage function for storing a group of data which includes language data corresponding to a plurality of languages in a storage device; a language selection function for selecting a language used for an operation of an information processing device among the plurality of languages based on an operation input from an operator; and a data deletion function for deleting unselected language data other than language data corresponding to the selected language among the language data stored in the storage device to increase free capacity of the storage device if storage capacity of the storage device falls short.

An information processing program according to a twelfth aspect of the present invention is, in the eleventh aspect, characterized in that the information processing program allows a computer to achieve: an input reception function for receiving an instruction input from an operator for instructing whether the unselected language data is to be deleted if storage capacity of the storage device falls short; and a function for deleting the unselected language data by the data deletion function if an instruction input for instructing to delete the unselected language data is received by the input reception function.

By applying software or firmware including the information processing program according to the tenth to twelfth aspects to a personal computer (PC) as well as a device such as an image taking apparatus (electronic camera, digital camera), a video playback device (video cassette recorder, television set), a digital camera, or a mobile telephone, the information processing device and the information processing method of the present invention can be provided.

According to the present invention, free capacity of the storage device can be increased and storage capacity can be effectively utilized by deleting the language data (unselected language data) corresponding to the languages which are not selected as the language used for an operation of the information processing device.

### BRIEF DESCRIPTION OF THE DRAWINGS

FIG. 1 is a front perspective view showing an image taking apparatus comprising an information processing device according to an embodiment of the present invention;

FIG. 2 is a rear perspective view showing an image taking apparatus comprising an information processing device according to an embodiment of the present invention;

FIG. 3 is a block diagram showing a main configuration of an image taking apparatus 10;

FIG. 4 is a flow chart showing a flow of a process for initial setting of an image taking apparatus 10;

FIG. 5 shows an exemplary screen for selecting a language;

FIG. 6 is a block diagram schematically showing a storage region in a flash memory 58;

FIG. 7 is a flow chart showing a flow of a process at the time of image taking of an image taking apparatus 10;

FIG. 8 is a flow chart showing a second embodiment of a process at the time of image taking of an image taking apparatus 10;

FIG. 9 shows an exemplary determination screen for determining whether unselected language data is to be deleted;

FIG. 10 shows an exemplary warning screen;

FIG. 11 is a flow chart showing a third embodiment of a process at the time of image taking of an image taking apparatus 10;

FIG. 12 shows an exemplary warning screen;

FIG. 13 is a flow chart showing a fourth embodiment of a process at the time of image taking of an image taking apparatus 10; and

FIG. 14 is a flow chart showing a flow of a process in the case where language selection is performed at a later time other than initial setting.

### DETAILED DESCRIPTION OF THE PREFERRED EMBODIMENT(S)

Preferred embodiments of information processing devices, information processing methods and information processing programs according to the present invention will now be described below in connection with the accompanying drawings.

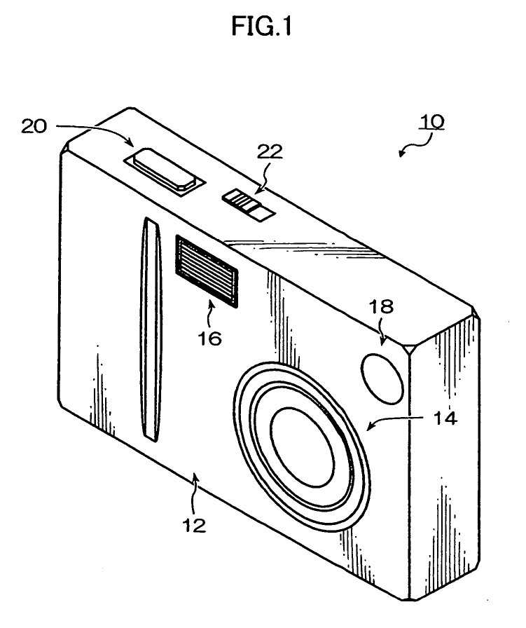

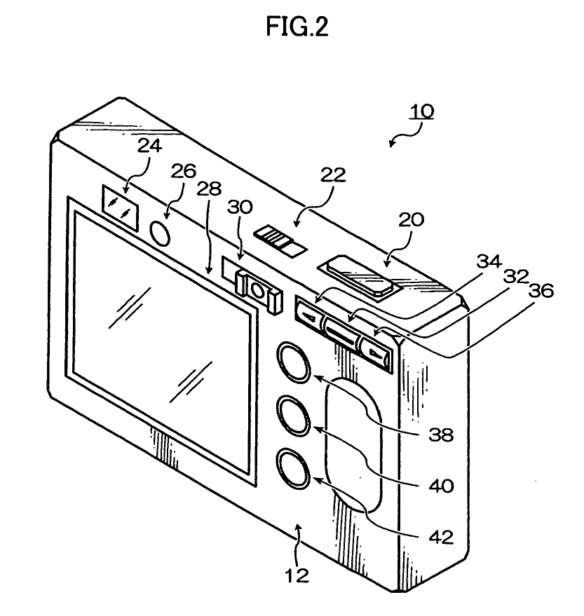

FIG. 1 and FIG. 2 are diagrams showing an image taking apparatus (electronic camera, digital camera) comprising an information processing device according to an embodiment of the present invention. FIG. 1 is a front perspective view, and FIG. 2 is a rear perspective view. A camera body 12 of the image taking apparatus 10 according to the present embodiment is formed in a flattened square box-shaped form. As shown in FIG. 1, there are provided image taking lenses 14, a strobe lamp 16, a finder window 18 and the like on the front surface of the camera body 12, and there are provided a release button 20 and a power supply switch 22 on the top surface of the camera body. As shown in FIG. 2, there are provided a finder ocular portion 24, a finder lamp 26, a liquid crystal monitor 28, a mode switch 30, a zoom button 32, a macro button 34, a strobe button 36, a MENU/OK button 38, a BACK button 40, a display button 42 and the like on the rear surface of the camera body 12.

The power supply switch 22 is a sliding switch, and the power supply of the image taking apparatus 10 is turned on/off by sliding and operating the power supply switch 22. The image taking lenses 14 are configured with retractable zoom lenses and extend from the front of the camera body 12 by turning on the power supply of the image taking apparatus 10. The image taking lenses 14 retract into the camera body 12 by turning off the power supply of the image taking apparatus 10.

The release button 20 provided on the top surface of the camera body 12 is configured as a two-stage stroke type button which has so called a “half-pressed state” and a “full-pressed state”, and therefore in the “half-pressed state” an Auto Focus (AF) function and an Auto Exposure (AE) function are performed, and in the “full-pressed state” image taking is performed.

The liquid crystal monitor 28 provided on the rear surface of the camera body 12 is used as a monitor for replaying a taken image, and is used as an electronic view finder at the time of image taking. The display button 42 functions as an on/off switching button of the electronic view finder. The liquid crystal monitor 28 is also utilized as a display screen for a user interface, and information such as menu, selection item or setting information is displayed on the liquid crystal monitor 28 as required. Note that other types of display devices such as an organic electro-luminescence (EL) display can be used instead of the liquid crystal monitor 28.

The mode switch 30 functions as a switch which switches between modes of the image taking apparatus 10, and is switched between an “image taking mode” which performs image taking of a still image and a “replay mode” which replays a taken image depending on its setting position.

The zoom button 32 is configured as a seesaw button which is swingable in the up and down directions, and functions as an operation button at the time of a zoom operation. More specifically, under the image taking mode, zooming is operated in a tele direction by operating the zoom button 32 in the up direction, and the zooming is operated in a wide direction by operating the zoom button 32 in the down direction.

The zoom button 32 functions also as a zoom button for a replayed image under the replay mode. More specifically, under the replay mode, the replayed image is displayed in an enlarged scale by operating the zoom button 32 in the up direction, and the replayed image is displayed in a reduced scale by operating the zoom button 32 in the down direction.

The macro button 34 functions as a button which switches between on and off of a macro function (close-up function), and under the image taking mode the macro function is switched on or off by pressing the macro button 34. The macro button 34 functions also as a frame back button (a button which instructs that an image of an immediately preceding frame be displayed) under the replay mode.

The strobe button 36 functions as a button which switches between strobe modes, and under the image taking mode the strobe mode is set to each of a strobe emission mode and a strobe emission inhibit mode by pressing the strobe button 36. The strobe button 36 functions also as a frame advance button (a button which instructs that an image of an immediately following frame be displayed) under the replay mode.

The MENU/OK button 38 functions as a button which instructs to display a menu screen, and by pressing the MENU/OK button 38 a menu screen is displayed on the liquid crystal monitor 28. The MENU/OK button 38 functions also as a button which instructs the execution of a determination or an operation of an item selected from the menu screen. The BACK button 40 functions as a button which instructs to cancel a selected item on the menu screen or to return to an immediately preceding state.

In addition, in the case where the menu screen is displayed, three buttons of the zoom button 32, the macro button 34, and the strobe button 36 function as a cross key, and selection of menu items is performed by utilizing these three buttons.

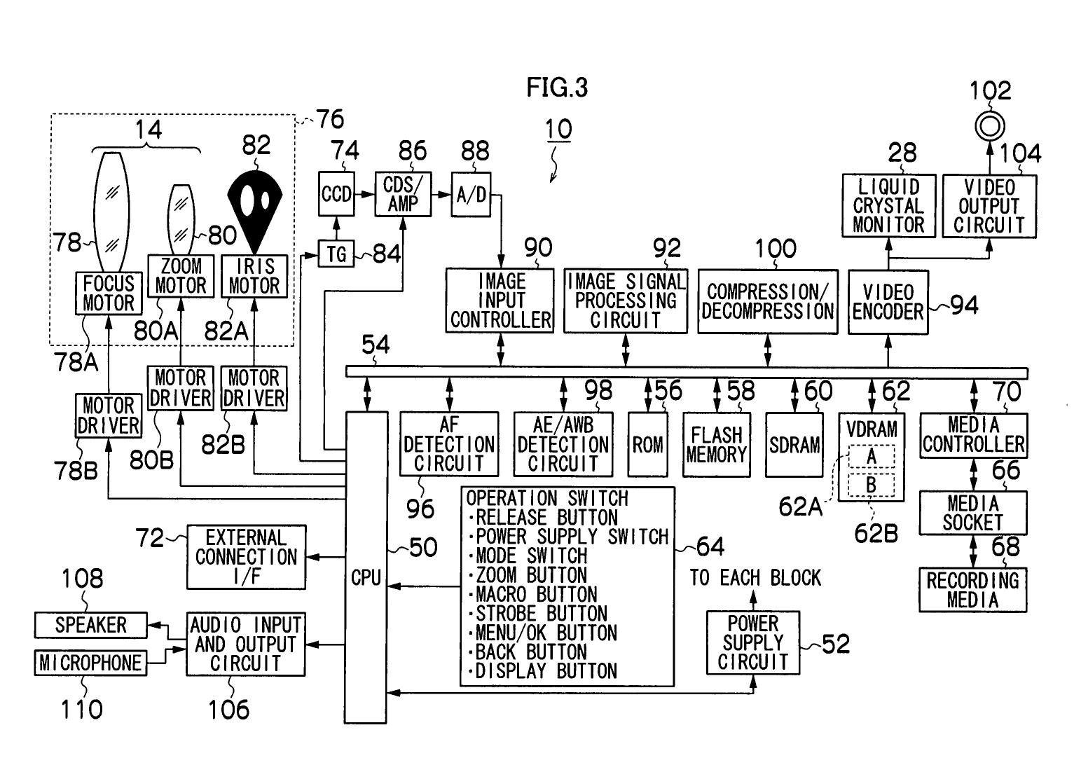

FIG. 3 is a block diagram showing a main configuration of an image taking apparatus 10. The image taking apparatus 10 shown in FIG. 3 is a digital camera having a recording function and a replay function of still images and moving images, and an operation of the entire image taking apparatus 10 is totally controlled by a central processing unit (CPU) 50. The CPU 50 functions as a control device which controls the present camera system according to a predetermined program, and functions also as a operation device which executes various operations such as an auto exposure (AE) operation, an auto focus adjustment (AF) operation, a white balance (WB) adjustment operation. A power supply circuit 52 supplies power to each of blocks of the present camera system.

A Read Only Memory (ROM) 56 and a flash memory 58 are connected through a bus 54 to the CPU 50. The ROM 56 stores programs which are executed by the CPU 50 and a various types of data required to control and the like, and the flash memory 58 stores information of CCD pixel defects, a various types of constant/information with respect to the camera operation or the like. The flash memory 58 stores also language data (language data, font data, etc.) corresponding to a plurality of languages.

In addition, a memory (SDRAM: Synchronous Dynamic Random Access Memory) 60 is utilized as a loading area for a program and an operation working area for the CPU 50, and is also utilized as a temporary storage area for image data and voice data. A VRAM (Video Random Access Memory) 62 is a temporary storage memory dedicated for image data, and includes an A region 62A and a B region 62B. Note that the memory 60 and the VRAM 62 can be shared.

A group of operation switches 64 is a block which includes the release button 20, the power supply switch 22 and the like mentioned above. Signals from these various types of operation switches are input to the CPU 50, and the CPU 50 controls each of circuits of the image taking apparatus 10 based on the input signals, and performs, for example, a lens driving control, an image taking operation control, an image processing control, a recording/replay control of image data, a display control of the liquid crystal monitor 28 or the like.

The image taking apparatus 10 has a media socket (media insertion section) 66, and a recording media 68 can be inserted into the media socket 66. As a form of the recording media 68, various media such as a semiconductor memory card represented by an xD-PictureCard (™) and a SmartMedia (™), a small portable hard disk, a magnetic disk, an optical disk, a magnetic optical disk or the like can be used. A media controller 70 performs required signal conversion to transfer input and output signals suitable for the recording media 68 inserted into the media socket 66.

In addition, the image taking apparatus 10 comprises an external connection interface (I/F) unit 72 as a communication device to connect to a personal computer and the other external devices. The image taking apparatus 10 can transfer data between itself and an external device by connecting the image taking apparatus 10 and the external device by means of a USB cable or the like which is not depicted in the figure. Note that a communication system with the external device is not limited to the USB, and an EEE 1394, a Bluetooth and other communication systems can be applied.

An image taking function of the image taking apparatus 10 will now be described. When the image taking mode is selected by the mode switch 30, an image taking unit including a color CCD image sensor 74 (hereinafter referred to as a CCD 74) is powered on, and changes to a state where image taking is allowed.

A lens unit 76 is an optical unit which includes the image taking lenses 14 including a focus lens 78 and a zoom lens 80, and a multifunction aperture/mechanical shutter 82. Focusing of the image taking lenses 14 is performed by moving the focus lens 78 by means of a focus motor 78A, and zooming is performed by moving the zoom lens 80 by means of a zoom motor 80A. The driving control of the focus motor 78A and the zoom motor 80A is performed by a focus motor driver 78B and a zoom motor driver 80B respectively. The CPU 50 outputs control signals to the focus motor driver 78B and the zoom motor driver 80B and controls the drivers.

The aperture 82 is configured as a so-called turret aperture, and an aperture value (F value) is changed by rotating a turret board in which aperture holes of F 2.8 to F. 8 are provided. Driving of the aperture 82 is performed by an iris motor 82A. The driving control of the iris motor 82A is performed by an iris motor driver 82B. The CPU 50 outputs a control signal to the iris motor driver 82B and controls the driver.

Light which has passed through the lens unit 76 forms an image on a photoreceiving surface of the CCD 74. There are arranged a large number of photo diodes (photoreceiving elements) in a two dimensional manner on the photoreceiving surface of the CCD 74, and primary color filters of red (R), green (G) and blue (B) colors with each filter corresponding to each of the photo diodes are placed in a predetermined arrangement configuration (Bayer, G stripes, etc.). The CCD 74 has also an electronic shutter function for controlling a charge accumulation period of each photo diode (shutter speed). The CPU 50 controls the charge accumulation period in the CCD 74 through a timing generator (TG) 84.

An object image formed on the photoreceiving surface of the CCD 74 is converted into an amount of signal charges corresponding to the amount of incident light by each of the photo diodes. The signal charges accumulated in each of the photo diodes are read out successively as a voltage signal (image signal) corresponding to the signal charges based on driving pulses supplied from the TG 84 according to a command of the CPU 50.

A signal outputted from the CCD 74 is sent to an analog processing unit (CDS/AMP) 86, where sampling hold (correlation dual sampling process) of the R, G, and B signals for each pixel is performed, and after the signal is amplified the signal is applied to an A/D converter 88. The dot sequential R, G, and B signals converted into digital signals by the A/D converter 88 are successively stored in the memory 60 through an image input controller 90.

An image signal processing circuit 92 processes the R, G, and B signals, which are stored in the memory 60, according to a command of the CPU 50. More specifically, the image signal processing circuit 92 functions as an image processing device which includes a synchronization circuit (processing circuit which converts color signals into synchronized signals by interpolating spatial displacements of color signals associated with the color filter arrangement of a single plate CCD), a white balance correction circuit, a gamma correction circuit, an edge correction circuit, a luminance/color difference signal generation circuit and the like, and performs a predetermined signal processing utilizing the memory 60 according to a command of the CPU 50.

RGB image data inputted to the image signal processing circuit 92 is converted into a luminance signal (Y signal) and color difference signals (Cr signal, Cb signal) and a predetermined process such as gamma correction is performed to the data in the image signal processing circuit 92. The image data processed in the image signal processing circuit 92 is stored in the VRAM 62.

In the case where a taken image is outputted to the liquid crystal monitor 28 for monitoring, the image data is read from the VRAM 62, and sent to a video encoder 94 through the bus 54. The video encoder 94 converts the inputted image data into a signal of a predetermined system (e.g., a color composite image signal of the NTSC system) to output to the liquid crystal monitor 28.

Image data which represents a frame of image is alternately rewritten into the A region 62A and the B region 62B of the VRAM 62 by an image signal outputted from the CCD 74. Among the A region 62A and the B region 62B, the written image data is read out from the region other than the region in which image data is being rewritten. In such a manner, the image data in the VRAM 62 is periodically rewritten, and the image during image taking is displayed in real time on the liquid crystal monitor 28 by supplying the image signal generated from the image data to the liquid crystal monitor 28. An image taking user can determine an image taking angle of view by means of a video image (through moving image) displayed on the liquid crystal monitor 28.

When the release button 20 is half-pressed, the image taking apparatus 10 initiates an AE process and an AF process. More specifically, the image signal outputted from the CCD 74 is inputted to an AF detection circuit 96 and an AE/AWB detection circuit 98 through the image input controller 90 after A/D conversion.

The AE/AWB detection circuit 98 divides a screen into multiple areas (e.g., 8×8 or 16×16), each of which includes a circuit for integrating the RGB signals, and provides the integrated values to the CPU 50. The CPU 50 detects brightness of the object (object luminance) and calculates an exposure value suitable for the image taking (image taking EV value) based on the integrated values obtained from the AE/AWB detection circuit 98. An aperture value and a shutter speed are determined according to the calculated exposure value and a predetermined program diagram, and thus the CPU 50 controls the electronic shutter and the iris to obtain a correct exposure amount.

The AE/AWB detection circuit 98 also calculates an average integrated value for each color of RGB signals for each divided area at the time of automatic white balance adjustment, and provides the calculated results to the CPU 50. The CPU 50 obtains an integrated value for R, an integrated value for B, and an integrated value for G, calculates R/G and B/G ratios for each divided area, determines about a light source type based on the distributions of the R/G and B/G values in the color space of R/G and B/G axis coordinates, controls gain values to the R, G, and B signals of a white balance adjustment circuit (white balance correction value) depending on the determined light source type, and corrects the signal for each color channel. In this connection, the white balance adjustment will be described in detail below.

In AF control in the image taking apparatus 10, for example a contrast AF is applied which move the focus lens 78 such that a high frequency component of the G signal of the image signal is maximized. More specifically, the AF detection circuit 96 is configured by a high pass filter which passes only the high frequency component of the G signal, an absolute value processing unit, an AF area extraction unit which extracts signals in a focus target area preset in the screen (for example, a central portion of the screen), and an integration unit which integrates the absolute value data in the AF area.

The integrated value data obtained by the AF detection circuit 96 is informed to the CPU 50. The CPU 50 calculates focal point evaluation values (AF evaluation values) at multiple AF detection points while controlling the focus motor driver 78B to move the focus lens 78, and determines the lens position at which the evaluation value is maximized as a focal position. The CPU 50 controls the focus motor driver 78B such that the focus lens 78 is moved to the obtained focal position. Note that the calculation of the AF evaluation value is not limited to the aspect which utilizes the G signal, but may utilize the luminance signal (Y signal).

When the release button 20 is half-pressed, the AE/AF processes are performed, and when the release button 20 is full-pressed, an image taking operation for recording is started. The image data obtained in response to the full-pressed operation of the release button 20 is converted into the luminance/color difference signals (Y/C signals) in the image signal processing circuit 92, and is stored in the memory 60 after the predetermined process such as the gamma correction is performed.

The Y/C signals stored in the memory 60 is recorded in the recording media 68 through the media controller 70 after the Y/C signals are compressed by a compression and decompression circuit 100 according to a predetermined format. For example, a still image is recorded according to the Joint Photographic Experts Group (JPEG) format.

When the replay mode is selected by the mode switch 30, the compressed data of the last image file stored in the recording media 68 (the most recently recorded file) is read out. If the file associated with the last recording is a still image file, the compressed read out image data is decompressed into uncompressed YC signals through the compression and decompression circuit 100, and is outputted on the liquid crystal monitor 28 after the YC signals are converted into the signals for display through the image signal processing circuit 92 and the video encoder 94. Accordingly, the image content of the file in question is displayed on the screen of the liquid crystal monitor 28.

During replaying a frame of a still image (including replaying the beginning frame of a moving image), switching of replay target files (forward frame advance/backward frame advance) can be performed by operating the strobe button 36 (right key) or the macro button 34 (left key). An image file at the location to which the frame is advanced is read out from the recording media 68, and the still image or the moving image is replayed to display on the liquid crystal monitor 28 in a similar manner as mentioned above.

In addition, in the replay mode, if an external display such as a personal computer or a television set is connected to the image taking apparatus 10 through a video input and output terminal 102, the image data stored in the recording media 68 is processed by a video output circuit 104, and is replayed and displayed on the external display.

In addition, the CPU 50 is connected by an audio input and output circuit 106. The audio input and output circuit 106 is connected by a speaker 108 and a microphone 110, and replays to output various operation sounds in the image taking mode, the replay mode or the like, and is inputted with the voice signal at the time of image taking for the moving image.

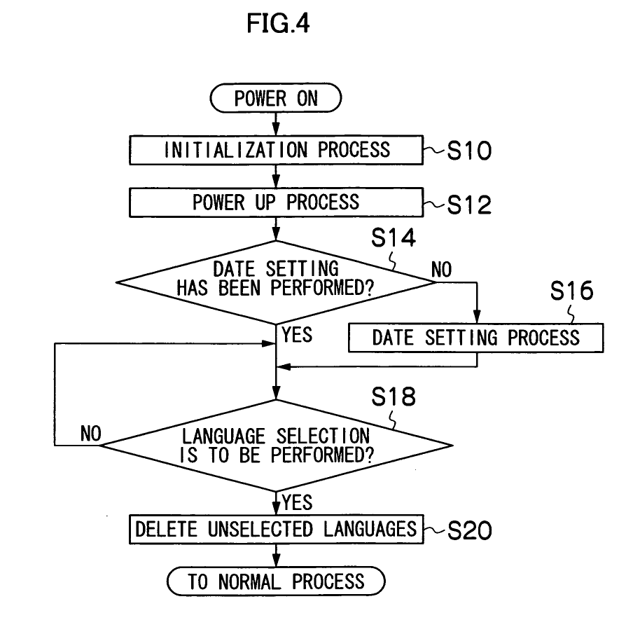

Next, an initial setting process of the image taking apparatus 10 according to the present embodiment will now be described with reference to FIG. 4 and later. Note that the process shown in FIG. 4 is performed at the time of purchase of the image taking apparatus 10 and the like for example. First, when the power supply is turned on by operating the power supply switch 22, an initialization process of various kinds of parameters used for a program which controls the image taking apparatus 10 (step S10), and a power up process (step S12) are performed. Next, if a date setting of the image taking apparatus 10 has not been performed (No in step S14), a display which prompts to set a date is displayed on the liquid crystal monitor 28, the process changes to a state to receive the date setting (step S16). When the date setting is completed, the process proceeds to step S18. On the other hand, if the date setting of the image taking apparatus 10 has been performed (Yes in step S14), the process proceeds to step S18.

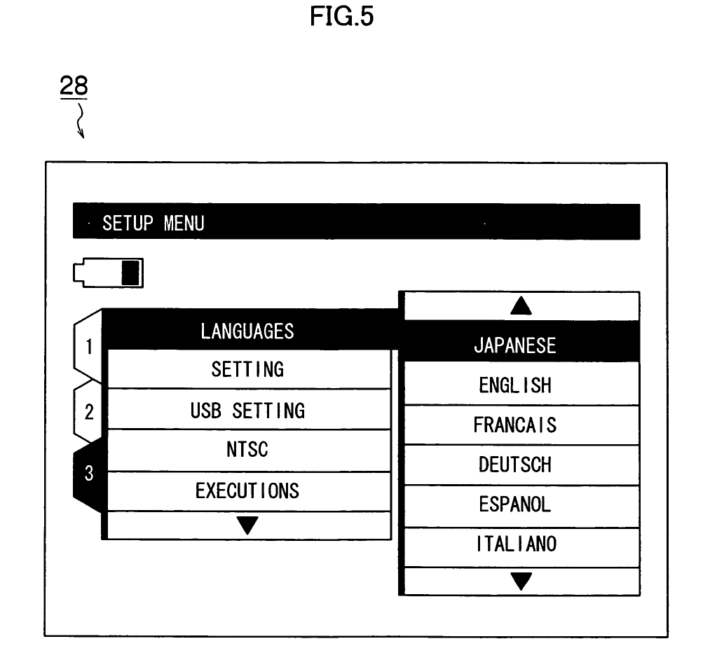

Next, as shown in FIG. 5, a screen which prompts to select a language used for operations of the image taking apparatus 10 and used for displays of operation menus or the like on the liquid crystal monitor 28 is displayed on the liquid crystal monitor 28, and the process changes to a state which receives the language selection (step S18). When the language selection is competed by operating the cross key (zoom button 32, macro button 34, strobe button 36) or the like, language data corresponding to the unselected languages (unselected language data) is deleted from the flash memory 58 (step S20).

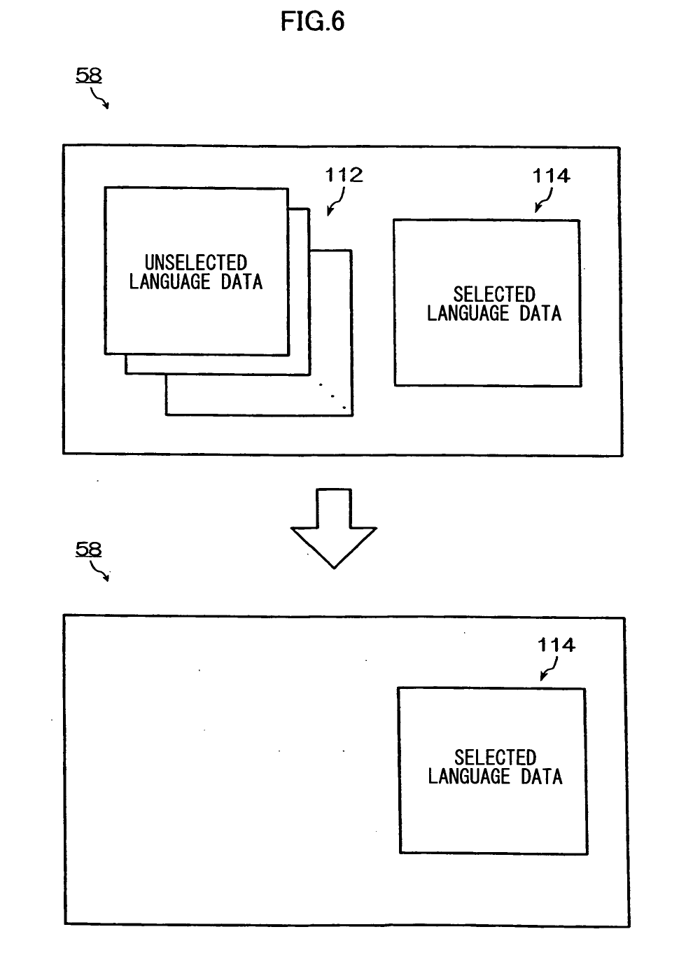

FIG. 6 shows a block diagram schematically showing a storage region in the flash memory 58. As shown in FIG. 6, in the image taking apparatus 10 according to the present embodiment, because the language data corresponding to the languages which were not selected at the time of initial setting (unselected language data) 112 is deleted, thus the language data in the flash memory 58 is only the selected language data 114, and free capacity of the flash memory 58 is increased (see the lower figure in FIG. 6). Accordingly, storage capacity of the flash memory 58 can be saved.

In addition, in the image taking apparatus 10 according to the present embodiment, if the language selection is desired to be changed, for example the deleted unselected language data 112 can be obtained from the external device which is connected through the external connection I/F unit 72, or the network.

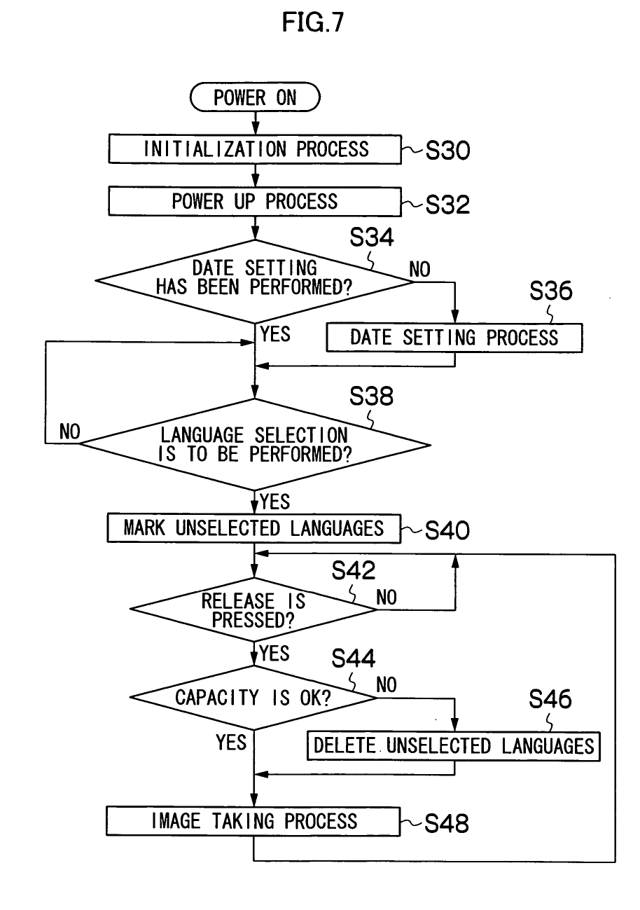

Note that in the embodiment mentioned above although the deletion of the unselected language data 112 is performed at the time of initial setting of the image taking apparatus 10, the deletion may be performed as required at the time of operation of the image taking apparatus 10. FIG. 7 is a flow chart showing a flow of a process at the time of image taking of the image taking apparatus 10.

First, at the time of initial setting of the image taking apparatus 10, when the power supply is turned on by operating the power supply switch 22, an initialization process of various kinds of parameters used for a program which controls the image taking apparatus 10 (step S30), and a power up process (step S32) are performed. Next, if a date setting of the image taking apparatus 10 has not been performed (No in step S34), a display which prompts to set a date is displayed on the liquid crystal monitor 28, the process changes to a state to receive the date setting (step S36). When the date setting process is completed, the process proceeds to step S38. On the other hand, if the date setting of the image taking apparatus 10 has been performed (Yes in step S34), the process proceeds to step S38.

Next, a screen which prompts to select a language used for operations of the image taking apparatus 10 and used for displays of operation menus or the like on the liquid crystal monitor 28 is displayed on the liquid crystal monitor 28 (refer to FIG. 5), and the process changes to a state which receives the language selection (step S38). When the language selection is competed by operating the cross key (zoom button 32, macro button 34, strobe button 36) or the like, language data corresponding to the unselected languages (unselected language data) is marked (step S40). Note that in step S40 the unselected language data may be attached with a predetermined mark or flag and data files identifying the unselected language data 112 or the like may be generated.

Next, at the time of an image taking process, when the release button 20 is pressed (half-pressed or full-pressed) (Yes in step S42), the CPU 50 obtains setting information such as the number of recording pixels or image quality, and refers to free capacity of the recording media 68. If the CPU 50 determines that there is no sufficient free capacity to record the taken image in the recording media 68 based on the above setting information, the CPU 50 refers to free capacity of the flash memory 58 (step S44). If it is determined based on the above setting information that there is sufficient free capacity to record the taken image in the flash memory 58 (Yes in step S44), then the image taking process is performed, and the taken image is saved in the flash memory 58 (step S48).

On the one hand, if it is determined based on the above setting information that there is not sufficient free capacity to record the taken image in the flash memory 58 (No in step S44), and if the CPU 50 determines that even if the unselected language data is deleted the free capacity to save the image cannot be reserved, then the image taking process is not performed, and a warning is displayed on the liquid crystal monitor 28 and the process is finalized. On the other hand, if the CPU 50 determines that if the unselected language data is deleted the free capacity to save the image can be reserved, then the unselected language data is deleted from the flash memory 58 (step S46), and the image taking process is performed (step S48).

According to the present embodiment, in the course of image taking being performed by the image taking apparatus 10, if free capacity of the recording media 68 for recording an image falls short, the image can be recorded in the flash memory 58, and if free capacity of the flash memory 58 also falls short, the image can be recorded in the flash memory 58 by deleting the unselected language data 112 to increase the free capacity of the flash memory 58.

In step S42, when the release button 20 is half-pressed or AE or AF operation is selected, the free capacity of the recording media 68 or the flash memory 58 is determined. However, for example, the free capacity may be determined when the release button 20 is full-pressed. In addition, the free capacity of the recording media 68 or the flash memory 58 may be determined at each time of image taking, and the unselected language data may be deleted or a display to prompt to change setting contents (the number of recording pixels or image quality etc.) may be performed at the stage when the free capacity falls short.

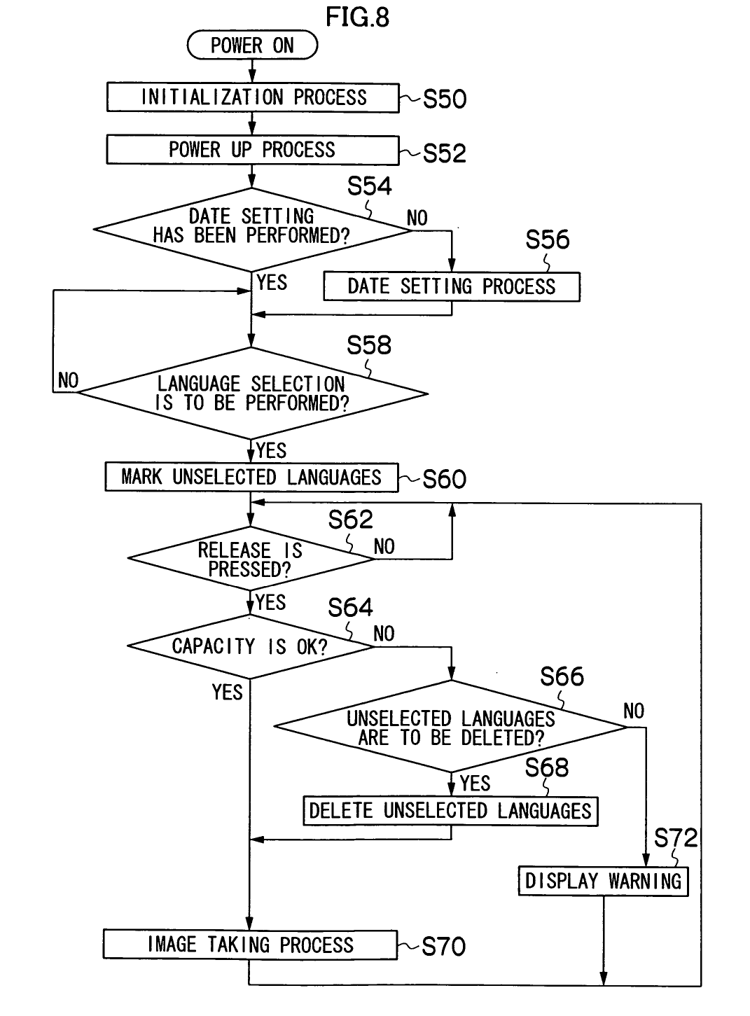

Another embodiment of a flow of a process at the time of image taking will now be described. FIG. 8 is a flow chart showing a second embodiment of a process at the time of image taking of the image taking apparatus 10. In this connection, since the processes at the time of initial setting (steps S50 to S60) are similar to the steps S30 to S40 of FIG. 7, the description thereof is omitted.

At the time of an image taking process, when the release button 20 is pressed (half-pressed or full-pressed) (Yes in step S62), the CPU 50 obtains setting information such as the number of recording pixels or image quality, and refers to free capacity of the recording media 68. If the CPU 50 determines that there is no sufficient free capacity to record the taken image in the recording media 68 based on the above setting information, the CPU 50 refers to free capacity of the flash memory 58 (step S64). If it is determined based on the above setting information that there is sufficient free capacity to record the taken image in the flash memory 58 (Yes in step S64), then the image taking process is performed, and the taken image is saved in the flash memory 58 (step S70).

On the one hand, if it is determined based on the above setting information that there is not sufficient free capacity to record the taken image in the flash memory 58 (No in step S64), and if the CPU 50 determines that even if the unselected language data is deleted the free capacity to save the image cannot be reserved, then the image taking process is not performed, and a warning is displayed on the liquid crystal monitor 28 and the process is finalized.

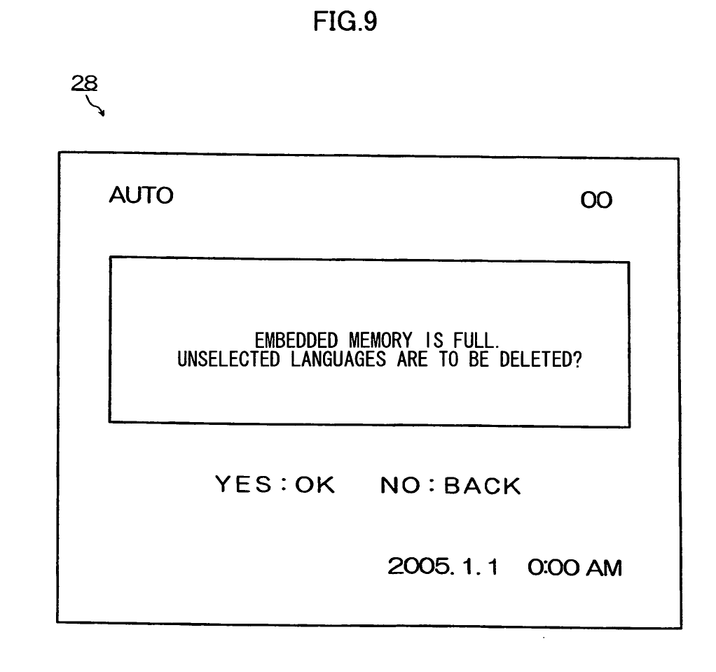

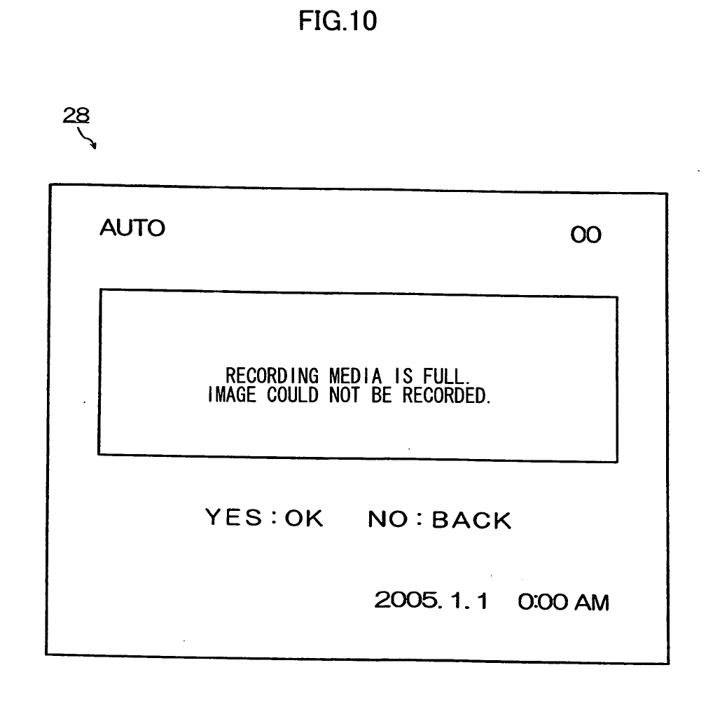

On the other hand, if the CPU 50 determines that if the unselected language data is deleted the free capacity to save the image can be reserved, then as shown in FIG. 9 a determination screen for determining whether the unselected language data is to be deleted is displayed on the liquid crystal monitor 28 (step S66). If the unselected language data is to be deleted, when it is detected that the MENU/OK button 38 is pressed (Yes in step S66), the unselected language data is deleted from the flash memory 58 (step S68), and the image taking process is performed (step S70). If otherwise the unselected language data is not to be deleted, when it is detected that the BACK button 40 is pressed (No in step S66), as shown in FIG. 10 a warning screen is displayed on the liquid crystal monitor 28, and the image is not saved and the process is finalized (step S72).

According to the present embodiment, during the image taking, if the free capacity of both of the recording media 68 and the flash memory 58 falls short, it can be selected whether the free capacity is reserved by deleting the unselected language data.

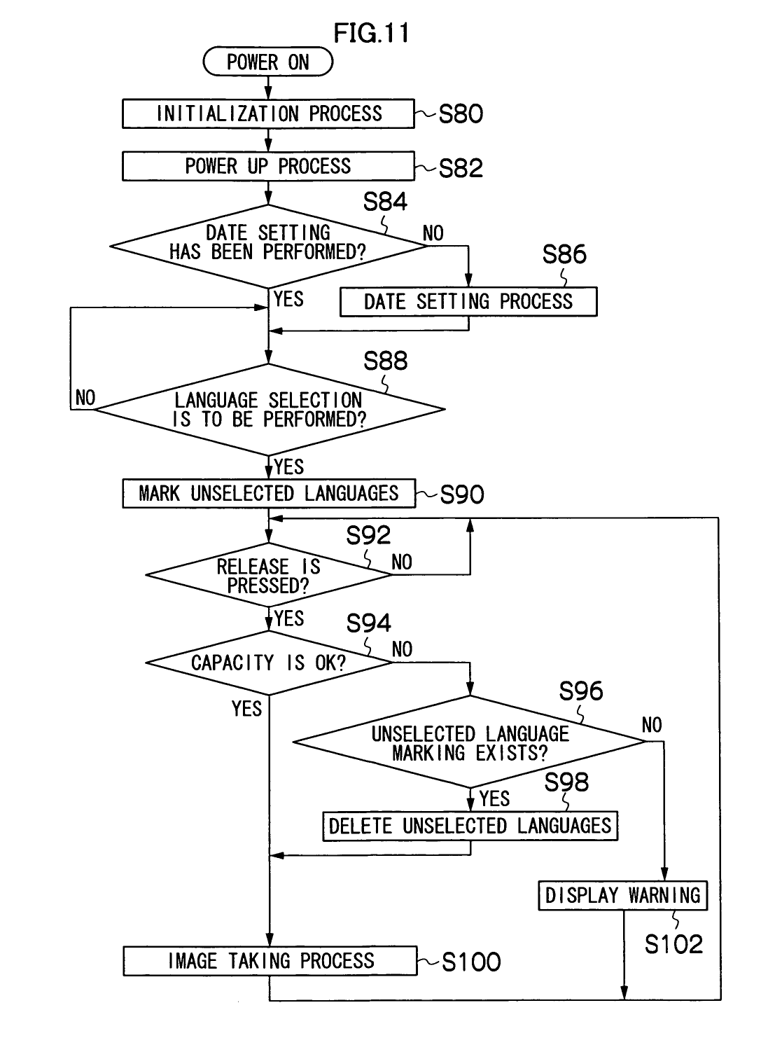

Next, a third embodiment of a flow of a process at the time of image taking will be described with reference to FIG. 11. First, at the time of initial setting of the image taking apparatus 10, when the power supply is turned on by operating the power supply switch 22, an initialization process of various kinds of parameters used for a program which controls the image taking apparatus 10 (step S80), and a power up process (step S82) are performed. Next, if a date setting of the image taking apparatus 10 has not been performed (No in step S84), a display which prompts to set a date is displayed on the liquid crystal monitor 28, the process changes to a state to receive the date setting (step S86). When the date setting process is completed, the process-proceeds to step S88. On the other hand, if the date setting of the image taking apparatus 10 has been performed (Yes in step S84), the process proceeds to step S88.

Next, a screen which prompts to select a language used for operations of the image taking apparatus 10 and used for displays of operation menus or the like on the liquid crystal monitor 28 is displayed on the liquid crystal monitor 28 (refer to FIG. 5), and the process changes to a state which receives the language selection (step S88). When the language selection is competed by operating the cross key (zoom button 32, macro button 34, strobe button 36) or the like (Yes in step S88), language data corresponding to the unselected languages (unselected language data) is marked (step S90). Note that in step S90 the unselected language data may be attached with a predetermined mark or flag and data files identifying the unselected language data 112 or the like may be generated. If otherwise the language selection is cancelled by the BACK button 40 or the like (No in step S88), the initial setting is finalized.

Next, at the time of an image taking process, when the release button 20 is pressed (half-pressed or full-pressed) (Yes in step S92), the CPU 50 obtains setting information such as the number of recording pixels or image quality, and refers to free capacity of the recording media 68. If the CPU 50 determines that there is no sufficient free capacity to record the taken image in the recording media 68 based on the above setting information, the CPU 50 refers to free capacity of the flash memory 58 (step S94). If it is determined based on the above setting information that there is sufficient free capacity to record the taken image in the flash memory 58 (Yes in step S94), then the image taking process is performed, and the taken image is saved in the flash memory 58 (step S100).

On the one hand, if it is determined based on the above setting information that there is not sufficient free capacity to record the taken image in the flash memory 58 (No in step S94), and if the CPU 50 determines that even if the unselected language data is deleted the free capacity to save the image cannot be reserved, then the image taking process is not performed, and a warning is displayed on the liquid crystal monitor 28 and the process is finalized.

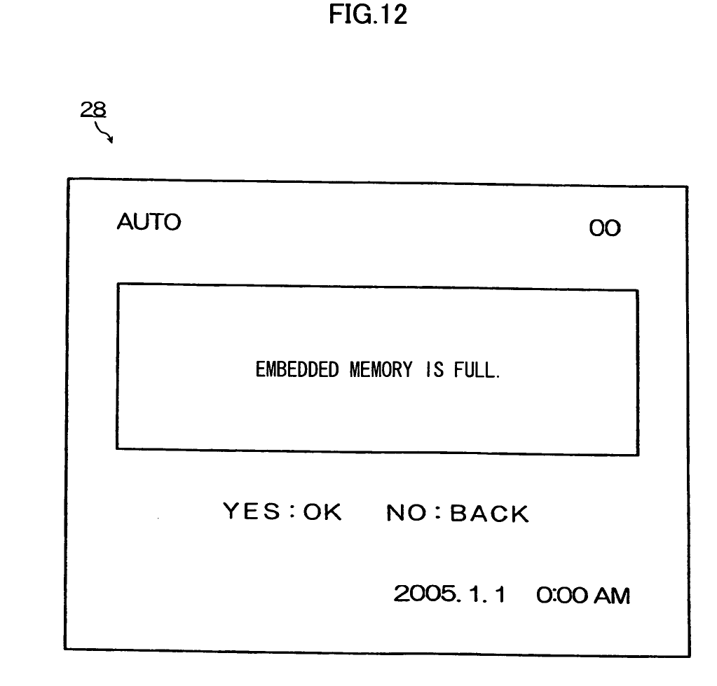

On the other hand, if the CPU 50 determines that if the unselected language data is deleted the free capacity to save the image can be reserved, the CPU 50 refers to the language data in the flash memory 58, and determines whether there is the marking of the unselected language data or whether the language selection was performed at the time of initial setting (step S96). If the language selection was performed at the time of initial setting and there is the marking of the unselected language data (Yes in step S96), the unselected language data is deleted from the flash memory 58 (step S98), and the image taking process is performed (step S100). If otherwise the language selection was not performed at the time of initial setting and there is no marking of the unselected language data (No in step S96), then a warning screen is displayed on the liquid crystal monitor 28 as shown in FIG. 12, and the image is not saved and the process is finalized (step S102).

According to the present embodiment, for example if image taking is performed without performing the initial setting such as a date setting or a language selection, unselected language data can be retained to allow the language selection to be performed at a later time.

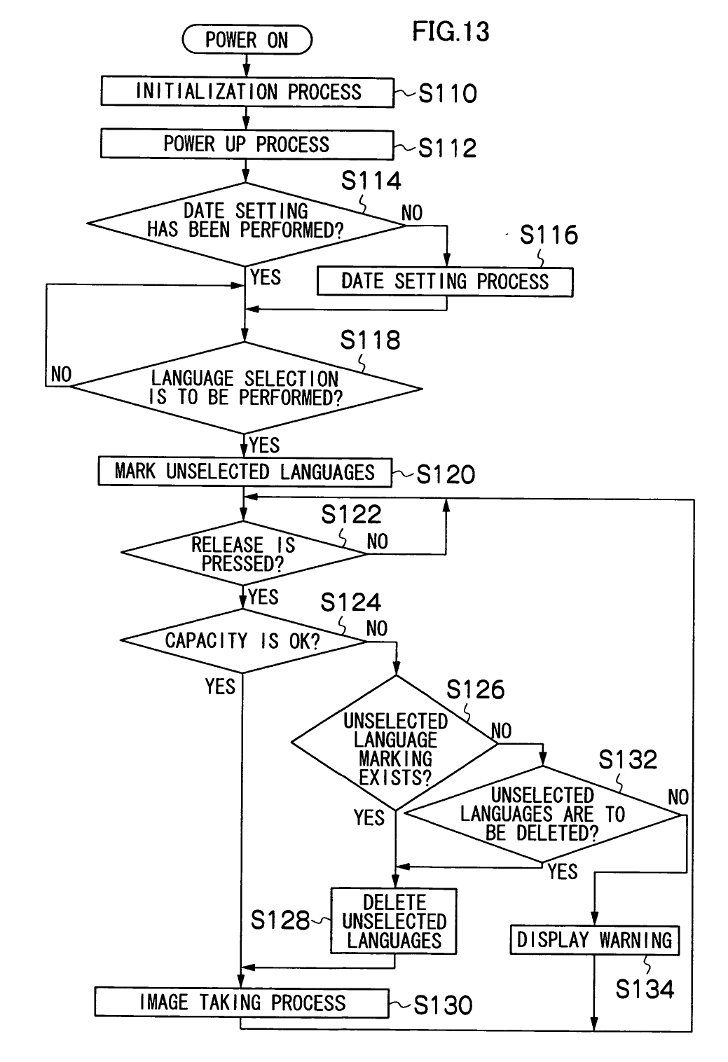

A fourth embodiment of a flow of a process at the time of image taking will now be described with reference to FIG. 13. In this connection, since the processes at the time of initial setting (steps S110 to S120) are similar to the steps S80 to S90 of FIG. 11, the description thereof is omitted.

At the time of an image taking process, when the release button 20 is pressed (half-pressed or full-pressed) (Yes in step S122), the CPU 50 obtains setting information such as the number of recording pixels or image quality, and refers to free capacity of the recording media 68. If the CPU 50 determines that there is no sufficient free capacity to record the taken image in the recording media 68 based on the above setting information, the CPU 50 refers to free capacity of the flash memory 58 (step S124). If it is determined based on the above setting information that there is sufficient free capacity to record the taken image in the flash memory 58 (Yes in step S124), then the image taking process is performed, and the taken image is saved in the flash memory 58 (step S130).

On the one hand, if it is determined based on the above setting information that there is not sufficient free capacity to record the taken image in the flash memory 58 (No in step S124), and if the CPU 50 determines that even if the unselected language data is deleted the free capacity to save the image cannot be reserved, then the image taking process is not performed, and a warning is displayed on the liquid crystal monitor 28 and the process is finalized. On the other hand, if the CPU 50 determines that if the unselected language data is deleted the free capacity to save the image can be reserved, then the CPU refers to the language data in the flash memory 58, and determines whether there is the marking of the unselected language data or whether a language selection was performed at the time of initial setting (step S126). If the language selection was performed at the time of initial setting and there is the marking of the unselected language data (Yes in step S126), the unselected language data is deleted from the flash memory 58 (step S128), and the image taking process is performed (step S130).

If the language selection was not performed at the time of initial setting and there is no marking of the unselected language data (No in step S126), then a determination screen for determining whether the unselected language data is to be deleted (refer to FIG. 9) is displayed on the liquid crystal monitor 28 (step S132). If the unselected language data is to be deleted, when it is detected that the MENU/OK button 38 is pressed (Yes in step S132), the unselected language data is deleted from the flash memory 58 (step S128), and the image taking process is performed (step S130). If otherwise the unselected language data is not to be deleted, when it is detected that the BACK button 40 is pressed (No in step S132), a warning message is displayed on the liquid crystal monitor 28 (refer to FIG. 10), and the image is not saved and the process is finalized (step S134).

According to the present embodiment, for example if an additional language selection is performed after a date setting or a language selection is performed, the language data can be retained.

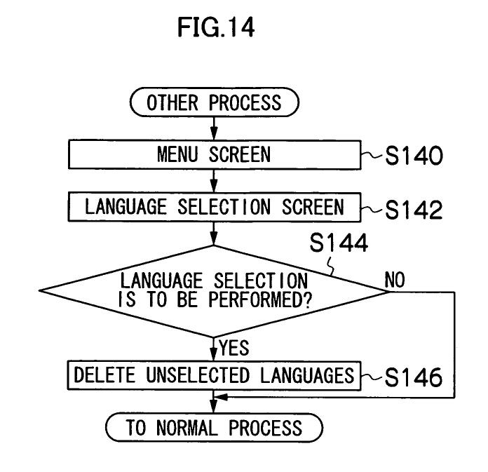

A flow of a process in the case where a language selection is not performed at the time of initial setting and the language selection is performed at a later time will now be described with reference to FIG. 14. First a menu screen (setup menu, refer to FIG. 5) is displayed by pressing the MENU/OK button 38 (step S140). Next, when a language selection menu is selected by operating the cross key (zoom button 32) mentioned above, a language selection screen is displayed on the liquid crystal monitor 28, the process changes to a state to receive a language selection (step S142). When the language selection is completed by operating the cross key (zoom button 32, macro button 34, strobe button 36) (Yes in step S144), language data corresponding to the unselected languages (unselected language data) is deleted from the flash memory 58 (step S146). On the other hand, when the language selection is cancelled by the BACK button 40 (No in step S144), the process returns to a normal process.

What is claimed is:

1. An information processing device comprising:
a storage device which stores a group of data including language data corresponding to a plurality of languages;
a language selection device which selects a language used for an operation of the information processing device among the plurality of languages based on an operation input from an operator; and
a data deletion device which deletes unselected language data other than language data corresponding to the selected language among the language data stored in the storage device to increase free capacity of the storage device.

2. The information processing device according to claim 1,
wherein the language selection device selects a default language as a language used for an operation of the information processing device if an instruction input for selection of the language used for an operation of the information processing device is not received from the operator, and
wherein the data deletion device deletes unselected language data other than language data corresponding to the default language among the language data stored in the storage device.

3. An information processing device comprising:
a storage device which stores a group of data including language data corresponding to a plurality of languages;
a language selection device which selects a language used for an operation of the information processing device among the plurality of languages based on an operation input from an operator; and
a data deletion device which deletes unselected language data other than language data corresponding to the selected language among the language data stored in the storage device to increase free capacity of the storage device if storage capacity of the storage device falls short.

4. The information processing device according to claim 3,
wherein the language selection device selects a default language as a language used for an operation of the information processing device if an instruction input for selection of the language used for an operation of the information processing device is not received from the operator, and
wherein the data deletion device deletes unselected language data other than language data corresponding to the default language among the language data stored in the storage device if storage capacity of the storage device falls short.

5. The information processing device according to claim 3,
wherein the storage device stores the unselected language data as a deletion candidate, and
wherein the data deletion device deletes the language data of the deletion candidate.

6. The information processing device according to claim 4,
wherein the storage device stores the unselected language data as a deletion candidate, and
wherein the data deletion device deletes the language data of the deletion candidate.

7. The information processing device according to claim 3, further comprising an input reception device which receives an instruction input from an operator for instructing whether the unselected language data is to be deleted if storage capacity of the storage device falls short,
wherein the data deletion device deletes the unselected language data if an instruction input for instructing to delete the unselected language data is received.

8. The information processing device according to claim 4, further comprising an input reception device which receives an instruction input from an operator for instructing whether the unselected language data is to be deleted if storage capacity of the storage device falls short,
wherein the data deletion device deletes the unselected language data if an instruction input for instructing to delete the unselected language data is received.

9. The information processing device according to claim 5, further comprising an input reception device which receives an instruction input from an operator for instructing whether the unselected language data is to be deleted if storage capacity of the storage device falls short,
wherein the data deletion device deletes the unselected language data if an instruction input for instructing to delete the unselected language data is received.

10. The information processing device according to claim 6, further comprising an input reception device which receives an instruction input from an operator for instructing whether the unselected language data is to be deleted if storage capacity of the storage device falls short,
wherein the data deletion device deletes the unselected language data if an instruction input for instructing to delete the unselected language data is received.

11. An information processing method comprising the steps of:
storing a group of data which includes language data corresponding to a plurality of languages in a storage device;
selecting a language used for an operation of an information processing device among the plurality of languages based on an operation input from an operator; and
deleting unselected language data other than language data corresponding to the selected language among the language data stored in the step of storing to increase free capacity of the storage device.

12. An information processing method comprising the steps of:
storing a group of data which includes language data corresponding to a plurality of languages in a storage device;
selecting a language used for an operation of an information processing device among the plurality of languages based on an operation input from an operator; and
deleting unselected language data other than language data corresponding to the selected language among the language data stored in the storage device to increase free capacity of the storage device if storage capacity of the storage device falls short.

13. The information processing method according to claim 12, further comprising a step of receiving an instruction input from an operator for instructing whether the unselected language data is to be deleted if storage capacity of the storage device falls short, wherein in the step of receiving the input, the unselected language data is deleted in the step of deleting the data if an instruction input for instructing to delete the unselected language data is received.

14. An information processing program allowing a computer to achieve:
a storage function for storing a group of data which includes language data corresponding to a plurality of languages in a storage device;
a language selection function for selecting a language used for an operation of an information processing device among the plurality of languages based on an operation input from an operator; and
a data deletion function for deleting unselected language data other than language data corresponding to the selected language among the language data stored by the storage function to increase free capacity of the storage device.

15. An information processing program allowing a computer to achieve:
a storage function for storing a group of data which includes language data corresponding to a plurality of languages in a storage device;
a language selection function for selecting a language used for an operation of an information processing device among the plurality of languages based on an operation input from an operator; and
a data deletion function for deleting unselected language data other than language data corresponding to the selected language among the language data stored in the storage device to increase free capacity of the storage device if storage capacity of the storage device falls short.

16. The information processing program according to claim 15, further allowing a computer to achieve:
a input reception function for receiving an instruction input from an operator for instructing whether the unselected language data is to be deleted if storage capacity of the storage device falls short; and
a function for deleting the unselected language data by the data deletion function if an instruction input for instructing to delete the unselected language data is received by the input reception function.
